(19) United States
(12) Patent Application Publication
(10) Pub. No.: US 2016/0072768 A1
(43) Pub. Date: Mar. 10, 2016

(54) Cellular-call activated, mechanical interrupt device for a wired connection to the Internet

(71) Applicant: Fadi Ibsies, Tigard, OR (US)

(72) Inventor: Fadi Ibsies, Tigard, OR (US)

(21) Appl. No.: 14/310,858

(22) Filed: Jun. 20, 2014

(51) Int. Cl. H04L 29/06; H04W 12/08

(52) U.S. Cl. CPC H04L 63/0209; H04W 12/08

(57) ABSTRACT

The present invention includes an Internet-kill switch for physically opening and closing a first Internet connection. The switch receives a remote signal via either a second, dedicated and independent Internet connection or by a cellular (voice) phone connection. A solenoid controlled electromechanical switch opens and closes a physical switch that creates a circuit or cuts a circuit that includes an Internet feed line. The switch arranges between an upstream apparatus such as an Internet modem and a downstream apparatus such as a router. When a cellular module receives a first activation code from a remote source, the solenoid closes the switch, enabling the downstream apparatus to connect normally to the Internet. When the cellular module receives a second activation code the solenoid opens the switch thus physically severing communication between the upstream apparatus and downstream apparatus, thus killing the Internet connection.

### PRIORITY CLAIM

No Priority Claim Made.

### FIELD OF THE INVENTION

The present invention relates to a remotely triggered switching device for Internet connections and more particularly to a mechanical disconnect network switch that is operated by an independent signal from a secondary source such as a smart phone, mobile phone, cellular phone, or other similar device.

### BACKGROUND

Both individuals and businesses rely heavily on computers linked to the Internet. And, with the increase in use by business and individuals, so there is a corresponding increase in cyber-related criminal activity. Once branch of cyber crime includes the hacking into computers connected to the Internet. With increasing amounts of personal data, client data, credit card information, banking information, and other confidential data saved on computers with Internet access, such cyber crimes become increasingly costly for businesses and individuals to prevent in the first instance and extremely time and resource consuming when a breach occurs.

A common weak link in Internet based cyber crimes is the common practice of both individuals and businesses to leave their server on and Internet link active 24-hours a day, seven days a week. Part of this practice is due to the desire for business owners and individuals to have instant and constant access to their own server when at remote locations. Thus, a dentist may want to review billing information at home or when traveling, which requires an Internet-based access to the server, which is located at his dental office. There are many similar other examples of situations where remote access is desired.

Cyber criminals rely on this open connection to hack into a computer with the sole intent of harvesting financial and identity information, commit fraud, or simply in malicious attacks designed to cripple the server with no apparent gain to the criminal.

Thus, there is an inherent conflict facing the business owner: On one hand, the owner wants ease of remote access to the server and on the other hand the owner wants security. To date, there has not been a satisfactory solution that optimizes remote access and security. One approach to thwart cyber crimes based of Internet-connected servers and computers is to simply turn off the computer or server and/or disconnect the server or computer from the Internet when not in use. This approach, if implemented, is completely affective in thwarting unauthorized access to the server/computer via the Internet. However, this requires active participation from the user, who must proactively decide to turn off the server or computer and disconnect it from the Internet. This requires diligence and is subject to human error. Further, this is not always practical: For example, a server might need to perform activities within the local area network, independent of the Internet connection and, therefore, turning off the server would result in inefficiencies in processing non-Internet related tasks. Further, this practice does not enable an authorized user to re-establish an Internet connection from a remote location. For example, the business owner cannot activate the business-server from his house.

Another effective approach is to physically unplug the Internet cable from the wall. This will allow the server to remain on thus enabling activities on the local area network, but it will prevent any incoming or outgoing Internet activity and thus safeguarding the local network from unauthorized use and attacks. Again, this approach is problematic as it relies on human diligence and is subject to human errors and also it does not address the need of activating the Internet connection from a remote location.

Yet another solution, described by Burton et al. in U.S. Pat. App. No. 2007/0058667 published on 2007 May 15, is a switch that physically switches off the Internet signal so there is no chance of the computer being hacked through the Internet while it is disconnected by the switch. This approach, however, is still problematic in that there is no way for an authorized user to re-activate the Internet from a remote location, as it requires the user to physically manipulate the switch to the on or off position at the same physical location.

Other solutions to disconnect the Internet from a computer include software-based approaches whereby the user can actively, or by a programming routine, instruct the computer to self-turn off the Internet. In this approach, the computer remains physically connected to the Internet, but the signal is stopped by software instructions to ignore the signal. This approach is again problematic as the software can also be hacked by cyber-criminals.

Other problems with the current state of the art include securing wireless routers where the physical link (wired) couples the Internet modem to a wireless router and then the wireless router is in wireless communication with a server. Again, current security protocols either use a software solution or a physical disconnection, both of which are problematic as just discussed.

Thus, there is a need for a device that can be controlled remotely, and when activated the device needs to be able to securely enable or disable the wired connection (physically disconnecting the electrical connection) to the Internet before that line reaches the router. This enables local area networks to remain on and working independent of the Internet connection status and creates a more secure local network by removing Internet based on predetermined criteria or based on the decision of the business owner. Importantly, there is a need for such a solution to provide a means for the authorized user to re-activate the Internet connection from a remote location. Ideally, such authorization would be transmitted securely by a secondary IP address provided by wireless company signal source such as a smart phone/cellular phone transmission.

### SUMMARY OF THE INVENTION

The present invention provides an Internet standby switch that enables a user to physically connect or disconnect a router, personal computer, server, or other wired Internet-connected computing device to or from the Internet when desired by using a second signal source with secure code. One contemplated example of a second signal source includes using a cellular phone signal to activate a mechanical switch to connect or disconnect from a remote location.

The switch physically severs or engages the connection—causing a physical break in the electrical connectivity or enabling physical connection of the electrical connectivity of the circuit that carries the Internet signal. This physical coupling or decoupling enables a complete switching off of the signal and therefore there is no chance of the computer (or other connected device) being hacked through the Internet. Yet, if the user desires activation of the Internet, activation can be made remotely, thus allowing the user to access his server remotely, even if the server is disconnected from the Internet by the device of the present invention.

### DRAWING

FIG. 1 is a representative diagram of the prior art.

FIG. 2 is a representative diagram of a preferred system according to one embodiment of the present invention.

FIG. 3 is a representative diagram of a switch of the embodiment of FIG. 2.

FIG. 4 is a representative diagram of an another preferred system according to an alternate embodiment of the present invention.

FIG. 5 is a circuit diagram of the electro-mechanical switch of FIG. 3.

### DESCRIPTION OF THE INVENTION

Possible preferred embodiments will now be described with reference to the drawings and those skilled in the art will understand that alternative configurations and combinations of components may be substituted without subtracting from the invention. Also, in some figures certain components are omitted to more clearly illustrate the invention.

The present invention, in one preferred embodiment, enables a remote user to call in via a cellular or land phone to a dedicated call-in number, which is linked to a cellular module. The cellular module includes software and hardware configured to enable an authorized user to identify themselves and then transmit a first or second activation code. The first activation code signals a solenoid to open an electromechanical switch that then interrupts a circuit that contains an Internet feed line. The second activation codes signals the solenoid to close the electromechanical switch, which then completes the circuit that contains the Internet feed line. Thus, an authorized user can secure any downstream devices from accessing the Internet, or from the Internet accessing those downstream devices by physically severing the Internet feed line.

In a second preferred embodiment, the present invention enable a remote user to securely contact by means of a distributed network (such as the Internet), from a web-connected device (smart phone, PC, laptop, tablet, desktop, or similar) a secure web-page that can receive a verification code to allow access through a firewall, which is connected to the Internet by a portal via the cellular module on a separate Internet connection and using a unique (static or dynamic) IP address. The verification code may be texted to a pre-determined set of e-mail addresses or phone numbers, or both. The verification code enables the user to access the secure web page, which in turn, enables the authorized user to signal a solenoid to open an electromechanical switch that then interrupts a circuit that contains an Internet feed line or to send a second activation codes that signals the solenoid to close the electromechanical switch, which then completes the circuit that contains the Internet feed line. In this embodiment, the switch device connects to the Internet by a SIM card with a firewall by wireless means such as a 4G or LTE wireless (phone/data) line connection.

Importantly, the device of the present invention has a unique address (either a phone number and/or Internet Protocol address, for example), which would be assigned by the cellular phone service provider. This unique address is separate from the IP address of the business as provided by the Internet Service Provider (for example, a cable company providing Internet Service with a Cable Modem). The cellular company would provide a unique SIM card with the unique ISP and the SIM card would have a firewall. Moreover, the ISP would provide a dynamic or static IP address as needed.

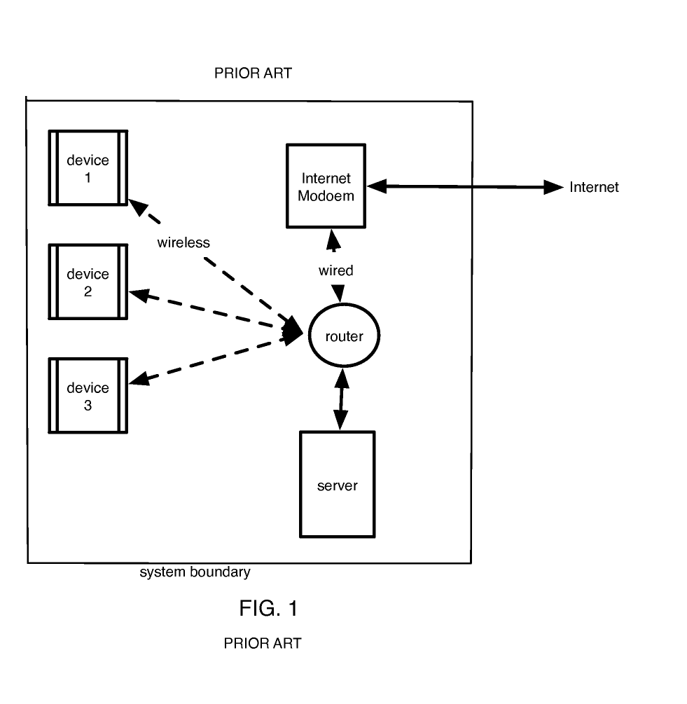

FIG. 1 illustrates the existing or prior-art system whereby an Internet feed line enters a system boundary by an upstream device such as an Internet modem. A router is downstream from the Internet modem and enables one or more peripheral devices to access the Internet. The router may include both wired and wireless connection, as would be well understood in the art. In the current art, software alone controls access to the Internet. Physical severing of the Internet line requires on-site, manual intervention whereby a user would physically unplug either the modem, router, or any number of the peripheral devices from the upstream device. In the case of wireless connectivity, the user would have to go to the upstream device (i.e., router) and unplug it from the source of the Internet (here, the Internet modem).

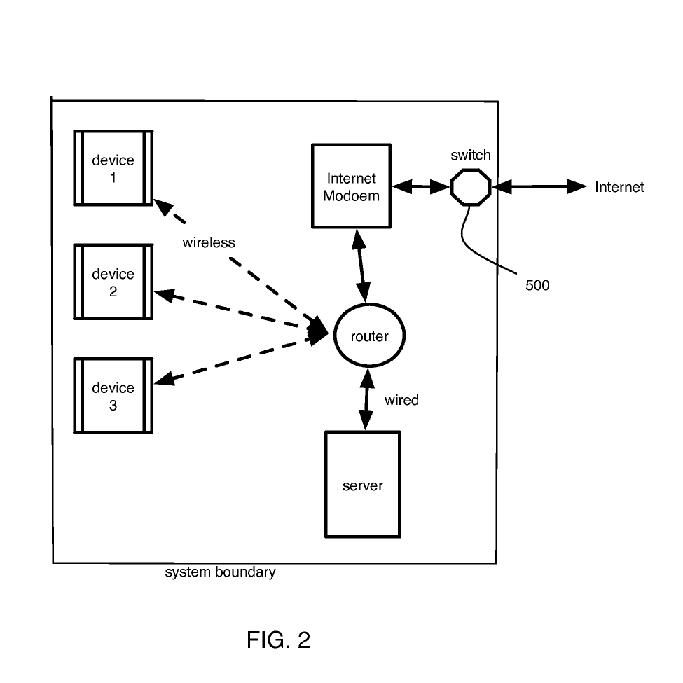

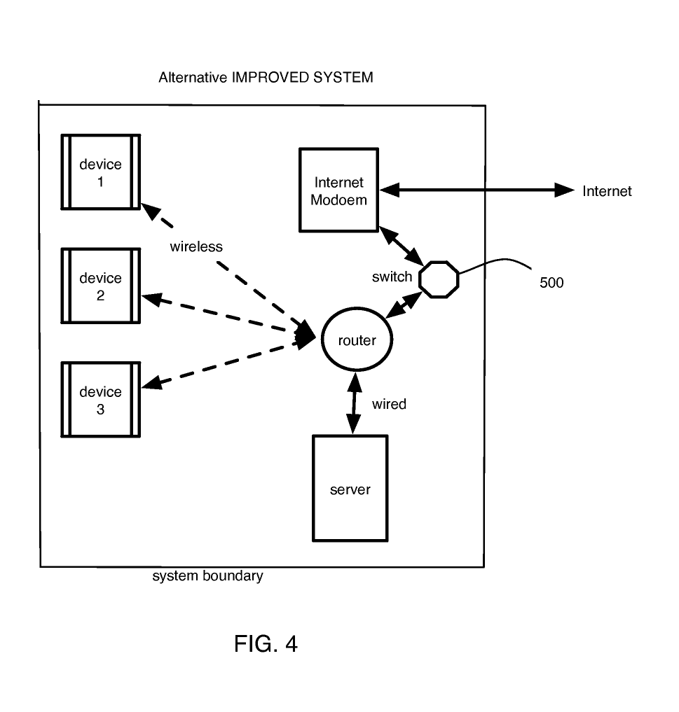

FIGS. 2 and 4 show an Internet Kill Switch according to a preferred embodiment of the present invention. In FIG. 2, the Internet Kill Switch is placed between the Internet Modem and the source of the Internet. In FIG. 4, the Internet Kill Switch is placed between the modem and the router. In both instances, the same kill switch can be deployed.

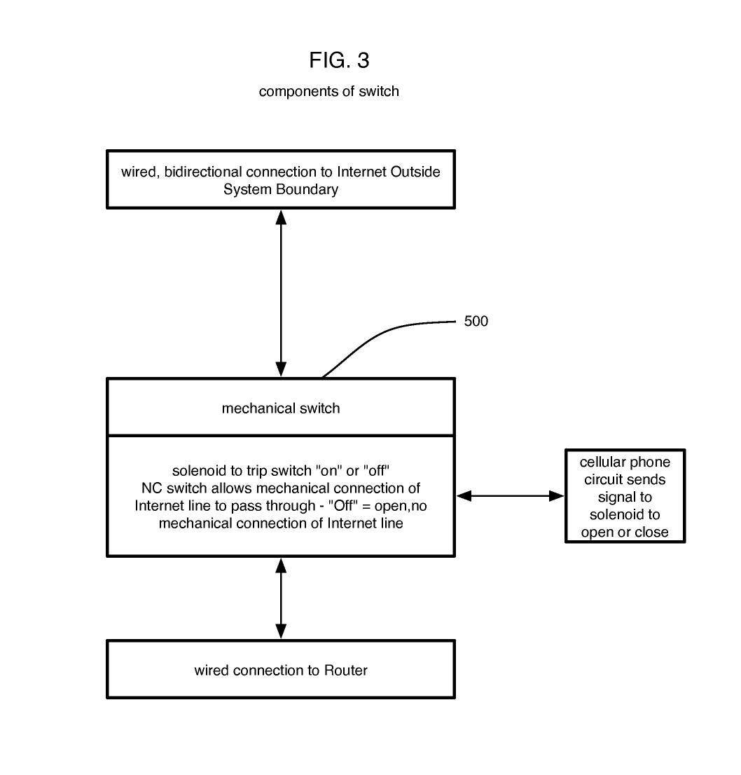

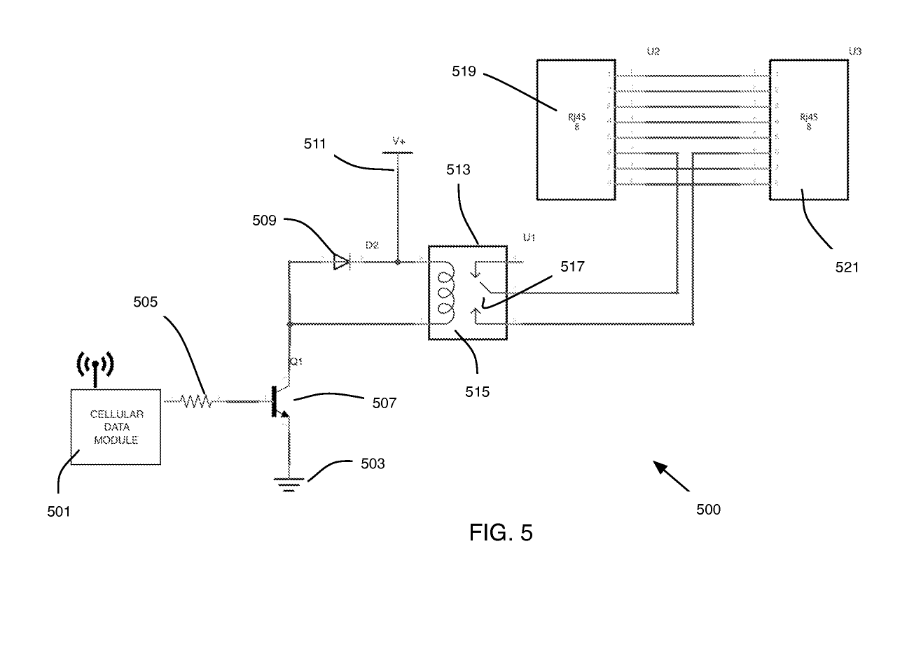

FIG. 3 depicts major components and function of the Internet Kill Switch. And, FIG. 5 illustrates a typical circuit diagram of the electromechanical components of the Internet Kill Switch.

Again referring to FIGS. 2 and 5, the Kill Switch 500 is positioned between the Internet feed (i.e. wall socket, or cable input line, DSL line, Fios line, or other similar) and the receiving device (i.e., Internet Modem). The Internet Kill Switch is a device for remote activation and deactivation of a (first or target) wired Internet connection between an Internet modem and a router. As such the device 500 includes (1) a cellular data module 501 configured to receive a user-inputted access code, the user-inputted access code being inputted remotely into the cellular data module by an incoming call to the cellular data module, or alternatively, by the user accessing a secure web-page through a Firewall via the SIM card on a second, independent, Internet connection, which couples the device 500 to the Internet by a wireless connection such as 4G or LTE signal; (2) a solenoid 513 in electrical and communication connection with the cellular data module whereby the user-inputted access code causes the solenoid to selectively open or close an electro-mechanical switch 517; (3) the electromechanical switch configured to selectively open and close to create a closed circuit electromechanically connecting an internet feed line in 519 to an internet feed line out 521; and wherein the internet modem being coupled to the internet feed line in and the router being coupled to the internet feed line out.

Again referring to FIGS. 4 and 5, the Internet Kill Switch can be positioned anywhere between an upstream apparatus connected to an Internet feed line and a downstream apparatus. For example, a device for remote activation and deactivation of a wired internet connection includes: (1) a cellular data module 501 configured to receive a user-inputted access code, the user-inputted access code being inputted remotely into the cellular data module by an incoming call to the cellular data module or by inputting appropriate authorization codes and verification codes from pre-determined users by means of a secure web-page through a firewall and portal and second independent Internet connection (i.e. wireless via 4G or LTE or similar cellular data line); (2) a solenoid 513 in electrical and communication connection with the cellular data module whereby the user-inputted access code causes the solenoid to selectively open or close an electro-mechanical switch 517; (3) the electromechanical switch configured to selectively open and close to create a closed circuit electromechanically connecting an internet feed line 519 in to an internet feed line out 521; and whereby (4) the internet feed line in is configured to be in wired communication with an upstream internet-enabled apparatus; and (5) the internet feed line out is configured to be in wired communication with a downstream apparatus.

As can be appreciated by those skilled in the art, the upstream apparatus is any one of the following including a wired or wireless router (or a combined wired and wireless router with one or more ports) and the downstream apparatus is any combination of peripheral devices includes laptops, computers, servers, tablets, smart phones, or other similar devices. In one contemplated embodiment the upstream internet-enabled apparatus comprises a router and the downstream apparatus comprises a server and/or computer, for example.

In another contemplated embodiment, the upstream internet-enabled apparatus comprises an Internet modem and the downstream apparatus comprises a router, for example.

The Internet Kill Switch can be a physically separate device, as described above, or, alternatively, it can be configured such that it is integral to an internet-enabled device such as an Internet Modem or Router or combined modem and router. The Kill Switch can be made integral to a peripheral device.

Additionally, there is an app for smart phones or other devices that can securely contact the unique IP address of the Device and signal activation or deactivation of the kill switch, or alternatively a land-line (phone) or cell-phone call can transmit the user's signals to the device.

In one example, an internet-connected device includes a robotic arm. The robotic arm includes the kill switch device 500 of the present invention. Additionally, the kill switch includes a physical button, green in color that operates the solenoid to connect the targeted Internet cable, thus enabling the company server to be in contact with the Internet. The kill switch further includes a second physical button, red in color that operates the solenoid to disconnect the targeted Internet cable, thus disabling the company server from being in contact with the Internet. The robotic arm can be programmed to articulate to, and then depress, the red or green button based on the received, authorized signal sent remotely by means discussed previously (above). For example, a red button can indicate the initiation of the signal that kills the Internet connection and a green button can indicate the initiation of the Internet connection. Clever icons can be used, too.

For illustrating a possible smart-device application, a robotic character can be animated to take a red pill (kill Internet) or a green pill (start Internet).

Additionally, the device 500 of the present invention can easily be adapted for use with Internet-linked robotic devices including cameras, toys, or other similar things. For example, a robotic camera device can be remotely controlled by using an Internet link, as is well-understood in the art. To prevent unwanted (hacked) use of the robotic device, a SIM-card can be incorporated with a unique ISP, thus allowing the kill switch device to be incorporated in the robot. This would provide and independent means for disabling the Internet connection and re-establishing the Internet connection, which would be beneficial to make the device more secure against unwanted use (from hackers, for example.)

Further, in the event that a fiber optic line is used such as FIOS or Google Fiber, the switch can be adapted to block light or physically sever the fiber optic line.

Other applications can be readily envisioned. For example, a wireless “baby monitoring” camera or other similar remote camera can include the internet kill switch according to the present invention so that parents can remotely disconnect the camera from the Internet to foil hackers. Yet another example is the ever-increasing number of autonomous robotic devices, such as vacuum cleaners, roving cameras, and other toys. Again, the present invention can easily be adapted for use in these Internet-connected appliances to allow an authorized user to sever the Internet connection and re-establish the connection by using the independent dynamic IP address, for example.

Although the invention has been particularly shown and described with reference to certain embodiments, it will be understood by those skilled in the art that various changes in form and detail may be made without departing from the spirit and scope of the invention.

I claim:

1. A device for remote activation and deactivation of a wired internet connection between an internet modem and a router, the device comprising:
a cellular data module configured to receive a user-inputted access code, the user-inputted access code being inputted remotely into the cellular data module by an incoming signal to the cellular data module;
a solenoid in electrical and communication connection with the cellular data module whereby the user-inputted access code causes the solenoid to selectively open or close an electro-mechanical switch;
the electromechanical switch configured to selectively open and close to create a closed circuit electromechanically connecting an internet feed line in to an internet feed line out;
the internet modem being coupled to the internet feed line in and the router being coupled to the internet feed line out.

2. The device of claim 1 wherein the incoming signal further comprises:
the cellular data module is configured to receive a cellular or land-line phone call transmitted by a cellular voice or data line connection to the device.

3. The device of claim 1 wherein the incoming signal further comprises:
the cellular data module is configured with a unique IP address and couples to the Internet by a cellular data line.

4. A device for remote activation and deactivation of a wired internet connection, the device comprising:
a cellular data module configured to receive a user-inputted access code, the user-inputted access code being inputted remotely into the cellular data module;
a solenoid in electrical and communication connection with the cellular data module whereby the user-inputted access code causes the solenoid to selectively open or close an electro-mechanical switch;
the electromechanical switch configured to selectively open and close to create a closed circuit electromechanically connecting an internet feed line in to an internet feed line out;
the internet feed line in configured to be in wired communication with an upstream internet-enabled apparatus; and
the internet feed line out configured to be in wired communication with a downstream apparatus.

5. The device of claim 4 wherein:
the upstream internet-enabled apparatus comprises a router.

6. The device of claim 5 wherein:
the downstream apparatus comprises a server.

7. The device of claim 5 wherein:
the downstream apparatus comprises a computer.

8. The device of claim 4 wherein:
the upstream internet-enabled apparatus comprises an internet modem and the downstream apparatus comprises a router.
